(19) United States
(12) Patent Application Publication
(10) Pub. No.: US 2018/0171550 A1
(43) Pub. Date: Jun. 21, 2018

(54) METHOD FOR PROVIDING WINDOW COVERINGS

(71) Applicant: Teresa Rodriguez, Hawthorne, NJ (US)

(72) Inventor: Teresa Rodriguez, Hawthorne, NJ (US)

(21) Appl. No.: 15/844,502

(22) Filed: Dec. 15, 2017

Related U.S. Application Data
(60) Provisional application No. 62/435,755, filed on Dec. 17, 2016.

(51) Int. Cl. D06P 5/30; A47H 23/00; B41J 3/407

(52) U.S. Cl. CPC D06P 5/30; A47H 2023/003; B41J 3/4078; A47H 23/00

(57) ABSTRACT

A method for providing window coverings comprising customized, photographic images imprinted on their surface to provide consumers with an attractive means of personalizing and improving the appearance of the windows, via the user's own treasured photographs.

### CROSS-REFERENCE TO RELATED APPLICATION

The present application is related to and claims priority from prior provisional application Ser. No. 62/435,755, filed Dec. 17, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of methods for printing images on fabric and more specifically relates to a method for providing window coverings comprising customized, photographic images imprinted on their surface to provide consumers with an attractive means of personalizing and improving the appearance of the windows, via the user's own treasured photographs.

### 2. Description of the Related Art

A basic, functional element of any home decor is a window. Windows can set the tone for a room, creating a pleasant mood through bright, sunny light and a direct view of the outdoors. Because windows let in vibrant sunshine, most consumers find it necessary to attach curtains or window blinds inside their windows, in order to offer necessary shade. Additionally, curtains and window blinds are used to protect the homeowner's privacy, particularly in the evening hours when light shining from overhead lights and floor lamps illuminate through the window, offering passersby a free view into the home. Produced in a variety of sizes and a broad selection of materials, curtains and window blinds are a necessary item found in most households. Unfortunately, blinds are not always aesthetically pleasing and unique to one's own home. Therefore, a need exists for methods for printing images on curtains to provide a unique way of remembering special memories.

Various attempts have been made to solve problems found in methods for printing images on fabric art. Among these are found in: U.S. Publication No. 20080136886 to Chao-Hsiung Yen; U.S. Pat. No. 7,072,733 to Magee et al; U.S. Pat. No. 6,631,985 to Koizumi et al. This prior art is representative of methods for printing images on fabric.

Ideally, a method for providing window coverings should be user-friendly and safe in-use and, yet should operate reliably and be manufactured at a modest expense. Thus, a need exists for a method for providing window coverings comprising customized, photographic images imprinted on their surface to provide consumers with an attractive means of personalizing and improving the appearance of the windows, via the user's own treasured photographs and to avoid the above-mentioned problems.

### BRIEF SUMMARY OF THE INVENTION

In view of the foregoing disadvantages inherent in the known methods for printing images on fabric art, the present invention provides a Method for Providing Window Coverings (also referred to herein as Curtain Memories). The general purpose of the present invention, which will be described subsequently in greater detail is to provide a method for providing window coverings comprising customized, photographic images imprinted on their surface to provide consumers with an attractive means of personalizing and improving the appearance of the windows, via the user's own treasured photographs.

A method for providing window coverings comprising the steps of: providing a printer member including a computer processor, a receiver member, and a printing mechanism; providing a textile fabric; providing images electronically to said printer member via said receiver member; printing said images onto said textile fabric via said printing mechanism; and providing at least one bracket member. The receiver member is electronically connected to the computer processor and is adapted to receive electronic signals from a transmitter member. The printing mechanism is electronically connected to the computer processor. The at least one bracket member is adapted to be connected to a supporting surface. The at least one bracket members is adapted to releasably hold the textile fabric over a window.

The present invention holds significant improvements and serves as a Method for Providing Window Coverings. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Method for Providing Window Coverings, constructed and operative according to the teachings of the present invention.

FIG. 1 shows a flowchart illustrating steps for Method for Providing Window Coverings according to an embodiment of the present invention.

FIG. 2 is a perspective view illustrating a printer member including computer processor of the Method for Providing Window Coverings according to an embodiment of the present invention.

FIG. 3A shows a perspective view illustrating images in the form of photographs on textile fabric of the Method for Providing Window Coverings according to an embodiment of the present invention.

FIG. 3B shows a perspective view illustrating images in the form of drawings on textile fabric of the Method for Providing Window Coverings according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to methods for printing images on fabric and more specifically relates to a method for providing window coverings (also referred to as Curtain Memories) comprising customized, photographic images imprinted on their surface to provide consumers with an attractive means of personalizing and improving the appearance of the windows, via the user's own treasured photographs.

Generally speaking, the Curtain Memories in the line could be manufactured from a variety of materials such as silk, satin, cotton and synthetic blends, to name a few considerations, and produced in sheer and solid offerings. The Curtain Memories will preferably accommodate virtually any household window, from small to large, and would offer consumers numerous design options and considerations including decorative accents, embellishments, and integrated solar lighting, just to name a few possibilities. The Curtain Memories is an entire line of window curtains and blinds, with the surface of each customized with the user's own photographic images.

With curtains in the line manufactured from a variety of materials as mentioned above, window blinds could be configured with either vertical or horizontal slats and manufactured of plastic, vinyl or even wooden material. Sizes available in the Curtain Memories line could accommodate virtually any household window, from small bathroom windows, to large picture windows. As with traditional window treatments, the Curtain Memories would boast adjustable rods and pull cords for use in opening and closing the curtains or blinds on demand Mounting brackets and hardware could also be included. The Curtain Memories could be a service offered in various retail establishments (or online) where window treatments are sold, as well as in other venues such as department stores and photo outlets.

Consumers who utilize this service could scan and upload images on-site, or could upload or email images directly to the Curtain Memories distributor from their computer or smartphone. Creating the Curtain Memories would involve utilizing a large format printer to enlarge a specific photographic image to the desired dimensions and imprint it on the designated curtain via high quality fabric ink. In the case of Curtain Memories window blinds, the image could be broken to accommodate the individual vertical or horizontal slats, creating a cohesive image when the blinds are closed. In addition to traditional photographic images of loved ones and friends, consumers could also opt to utilize vacation photos, as well as photographs of holidays, sporting events and special occasions on their Curtain Memories, thus accommodating a variety of design themes. As an added feature, decorative accents such as three-dimensional embellishments and integrated solar lighting could also be incorporated into the design of the Curtain Memories.

The Curtain Memories would transform the appearance of ordinary window treatments into personalized showpieces, offering a striking alternative to traditional curtains, sheers or window blinds. Importantly, these personalized showpieces would reflect special people, moments and events that matter in one's life, via truly unique window treatments. And, because the Curtain Memories would dramatically alter the appearance of the window, this change would be reflected in the overall decor of the room. Allowing consumers to change the scheme of a room, simply by changing their curtains or blinds, the Curtain Memories would provide users with an easy means of transforming any room in the home.

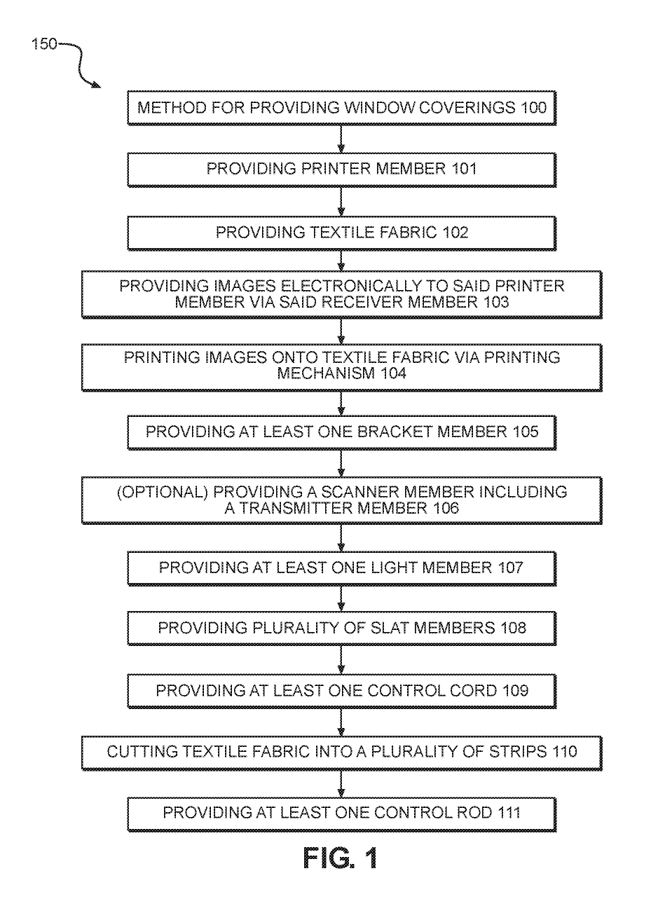

Referring now to FIG. 1, showing flowchart 150 illustrating steps for method for providing window coverings 100 according to an embodiment of the present invention of FIG. 1.

Method for providing window coverings comprising the steps of: step one 101 providing printer member 200 including computer processor 210, receiver member 220, and printing mechanism 230; step two 102 providing textile fabric 240; step three 103 providing images 250 electronically to printer member 200 via receiver member 220; step four 104 printing images 250 onto textile fabric 240 via printing mechanism 230; and step five 105 providing at least one bracket member 310. Method for providing window coverings 100 further comprising the step of step six 106 providing scanner member 260 including transmitter member 266. Method for providing window coverings 100 further comprising the step of: step seven 107 providing at least one light member 320. Method for providing window coverings 100 further comprising the steps of: step eight 108 providing plurality of slat members 330; step nine 109 providing at least one control cord 340; and step ten 110 cutting textile fabric 240 into plurality of strips 244. Method for providing window coverings 100 further comprising the steps of: step eleven 111 providing at least one control rod 350.

It should be noted that steps six, 106 through steps 11, 111 are optional steps and may not be implemented in all cases. Optional steps of method 100 are illustrated using dotted lines in FIG. 1 so as to distinguish them from the other steps of method 100.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

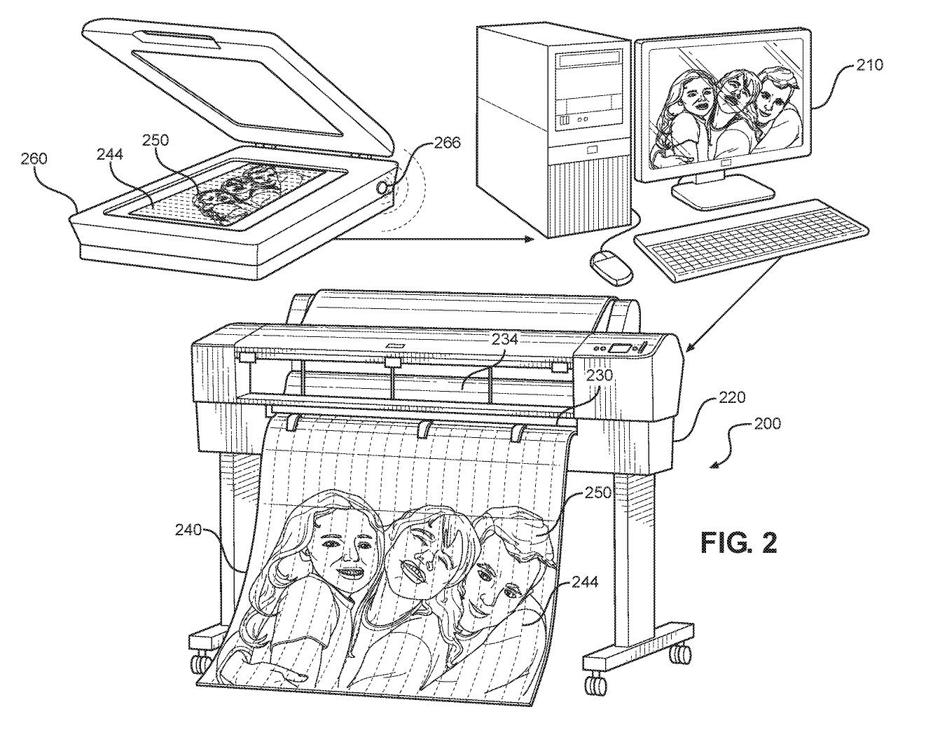

Referring now to FIGS. 2-4, showing perspective views illustrating method for providing window coverings 100 according to an embodiment of the present invention of FIG. 1.

Receiver member 220 is electronically connected to computer processor 210 and is adapted to receive electronic signals from a transmitter member. Receiver member 220 receives electronic signals from the transmitter member via the internet. Printing mechanism 230 is electronically connected to computer processor 210. Printing mechanism 230 includes plurality of ink jet nozzles 234.

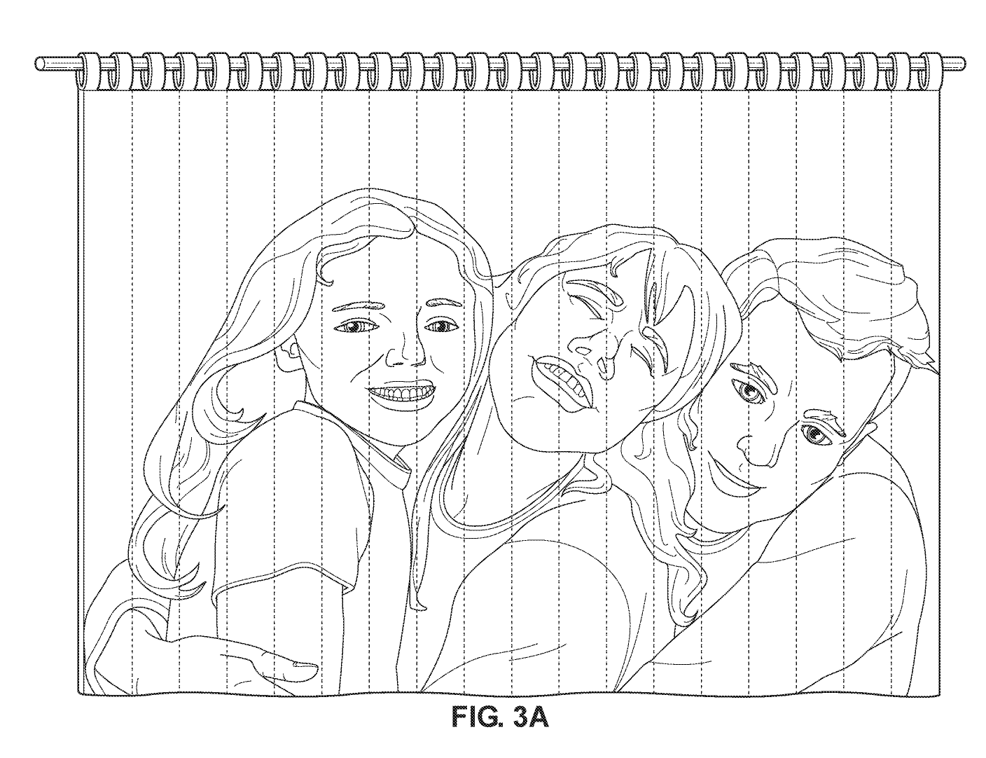

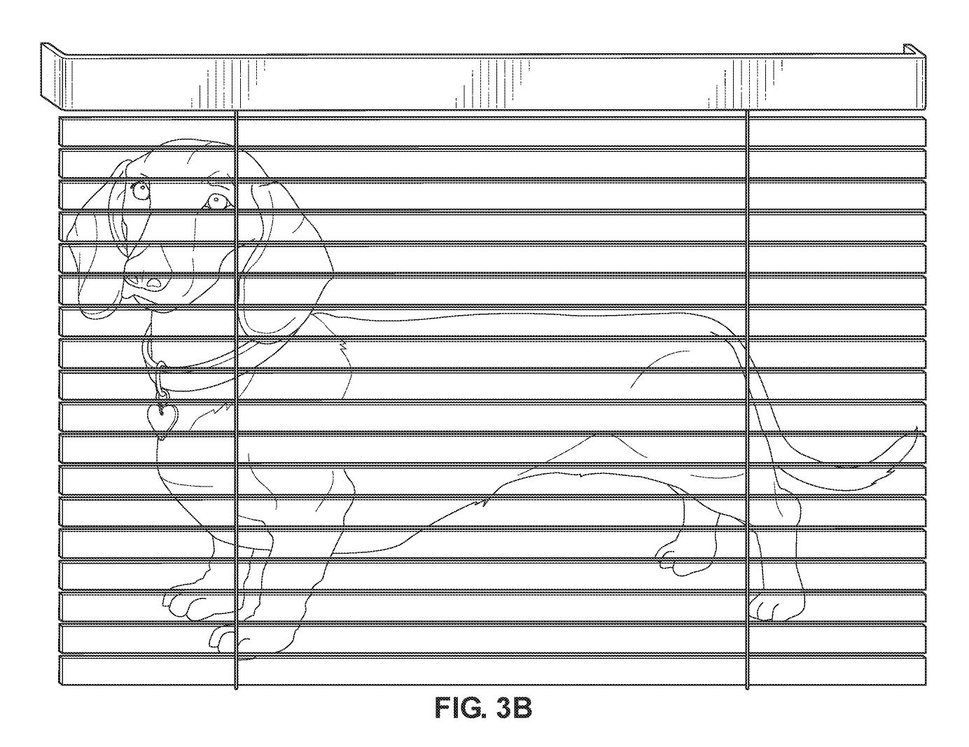

Textile fabric 240 is chosen from a group of textile fabrics 240 consisting of silk, satin, cotton, and synthetic fibers. Images 250 are formed from photographs 254. Photographs 254 display images 250 chosen from a group of images consisting of pets, sports designs, heraldry, nature scenes, outdoor scenes, landscapes, famous works of art, famous works of architecture, modes of transportation, famous personalities, holiday motifs, collectible articles, and maps as shown in FIG. 3A. Images 250 are formed from drawings 258. Drawings 258 display images 250 chosen from a group of images consisting of pets, sports designs, heraldry, nature scenes, outdoor scenes, landscapes, famous works of art, famous works of architecture, modes of transportation, famous personalities, holiday motifs, collectible articles, and maps as shown in FIG. 3B.

At least one bracket member 310 is adapted to be connected to a supporting surface. At least one bracket member 310 is adapted to releasably hold textile fabric 230 over window 302 as shown in in-use condition 300 of FIG. 3A. At least one light member 320 is adapted to be attached to at least one bracket member 310. At least one light member 320 is adapted to shine light upon textile fabric 230. At least one light member 320 is formed as a solar powered light member.

Transmitter member 266 is adapted to electronically send a scanned image to receiver 220 of printer member 200. Scanner member 260 is adapted to scan an image and send the scanned image electronically to receiver 220 of printer member 200 via transmitter member 266.

Plurality of slat members 330 are adapted to be connected in a parallel and side-by-side pattern. Plurality of slat members 330 are formed as vertical slat members 334 as shown in FIG. 3A. Plurality of slat members 330 are formed as horizontal slat members 338 as shown in FIG. 3B. Plurality of slat members 330 are respectively attached to plurality of slat members 338 via adhesive material 336. Adhesive material 336 is glue. Plurality of slat members 336 are formed from a material chosen from a group of materials consisting of plastic, metal, vinyl, and wood.

At least one control cord 340 is attached between plurality of slat members 330 and is adapted to move said plurality of slat members 330 into desired positions. Plurality of strips 244 are cut such that each of plurality of strips 244 is shaped to cover a respective plurality of slat members 330, such that image 250 printed onto textile fabric 240 can be projected when plurality of slat members 330 are positioned in a predetermined desired position. At least one control rod 350 is connected at least one control cord 340 and is adapted to move at least one control cord 340 and thereby move the plurality of slat members 330 into the desired positions.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A method for providing window coverings comprising the steps of:
providing a printer member including:
a computer processor;
a receiver member;
wherein said receiver member is electronically connected to said computer processor and is adapted to receive electronic signals from a transmitter member;
a printing mechanism;
wherein said printing mechanism is electronically connected to said computer processor;
providing a textile fabric;
providing images electronically to said printer member via said receiver member;
printing said images onto said textile fabric via said printing mechanism;
providing at least one bracket member;
wherein said at least one bracket member is adapted to be connected to a supporting surface; and
wherein said at least one bracket members is adapted to releasably hold said textile fabric over a window.

2. The method for providing window coverings of claim 1, wherein said images are formed from photographs.

3. The method for providing window coverings of claim 1, wherein said images are formed from drawings.

4. The method for providing window coverings of claim 2, wherein said photographs display images chosen from a group of images consisting of pets, sports designs, heraldry, nature scenes, outdoor scenes, landscapes, famous works of art, famous works of architecture, modes of transportation, famous personalities, holiday motifs, collectible articles, and maps.

5. The method for providing window coverings of claim 2, wherein said drawings display images chosen from a group of images consisting of pets, sports designs, heraldry, nature scenes, outdoor scenes, landscapes, famous works of art, famous works of architecture, modes of transportation, famous personalities, holiday motifs, collectible articles, and maps.

6. The method for providing window coverings of claim 1, further comprising the steps of:
providing a scanner member including:
a transmitter member;
wherein said transmitter member is adapted to electronically send a scanned image to said receiver of said printer member;
wherein said scanner member is adapted to scan an image and send said scanned image electronically to said receiver of said printer member via said transmitter member.

7. The method for providing window coverings of claim 1, wherein said printing mechanism includes a plurality of ink jet nozzles.

8. The method for providing window coverings of claim 1, wherein said receiver member receives electronic signals from said transmitter member via the internet.

9. The method for providing window coverings of claim 1, wherein said textile fabric is chosen from a group of textile fabrics consisting of silk, satin, cotton, and synthetic fibers.

10. The method for providing window coverings of claim 1, further comprising the steps of:
providing at least one light member;
wherein said at least one light member is adapted to be attached to said at least one bracket member; and
wherein said at least one light member is adapted to shine light upon said textile fabric.

11. The method for providing window coverings of claim 10, wherein said at least one light member is formed as a solar powered light member.

12. The method for providing window coverings of claim 1, further comprising the steps of:
providing a plurality of slat members;
wherein said plurality of slat members are adapted to be connected in a parallel and side-by-side pattern;
providing at least one control cord;
wherein said at least one control cord is attached between said plurality of slat members and is adapted to move said plurality of slat members into desired positions; and
cutting said textile fabric into a plurality of strips;
wherein said plurality of strips are cut such that each of said plurality of strips is shaped to cover a respective said plurality of slat members, such that said image printed onto said textile fabric can be projected when said plurality of slat members are positioned in a predetermined desired position.

13. The method for providing window coverings of claim 12, wherein said plurality of slat members are formed as horizontal slat members.

14. The method for providing window coverings of claim 12, wherein said plurality of slat members are formed as vertical slat members.

15. The method for providing window coverings of claim 12, wherein said plurality of slat members are respectively attached to said plurality of slat members via an adhesive material.

16. The method for providing window coverings of claim 15, wherein said adhesive material is glue.

17. The method for providing window coverings of claim 12, wherein said plurality of slat members are formed from a material chosen from a group of materials consisting of plastic, metal, vinyl, and wood.

18. The method for providing window coverings of claim 12, further comprising the steps of:
providing at least one control rod;
wherein said at least one control rod is connected said at least one control cord and is adapted to move said at least one control cord and thereby move said plurality of slat members into said desired positions.
